(19) United States
(12) Patent Application Publication
(10) Pub. No.: US 2013/0057570 A1
(43) Pub. Date: Mar. 7, 2013

(54) DISPLAY APPARATUS

(71) Applicants: Takuya Higaki, Chiba-shi (JP); Shunichi Shido, Mobara-shi (JP); Hideo Mori, Yokohama-shi (JP)

(72) Inventors: Takuya Higaki, Chiba-shi (JP); Shunichi Shido, Mobara-shi (JP); Hideo Mori, Yokohama-shi (JP)

(73) Assignee: CANON KABUSHIKI KAISHA, Tokyo (JP)

(21) Appl. No.: 13/596,737

(22) Filed: Aug. 28, 2012

(30) Foreign Application Priority Data
Sep. 6, 2011 (JP) 2011-193533

(51) Int. Cl. G09G 5/02

(52) U.S. Cl. 345/589

(57) ABSTRACT

A display apparatus including an image display unit in which a plurality of pixels have self light-emitting elements is arranged, a first unit configured to accumulate a luminance decrease amount per unit time for each of the pixels, and to set the accumulated amount as a first luminance decrease amount, a second unit configured to detect a current flowing in the self light-emitting element or a voltage value of the self light-emitting element for each of the pixels, and to calculate a second luminance decrease amount from a detected current value or voltage value, and a correction unit configured to correct input image data using one of the first luminance decrease amount or the second luminance decrease amount.

### BACKGROUND OF THE INVENTION

1. Field of the Invention

The present invention relates to a display apparatus which displays images using pixels that include self light-emitting elements. In particular, the present invention relates to a display apparatus that corrects an image based on an amount of decrease in luminance, and displays the image.

2. Description of the Related Art

Currently, there is active research and development of self light-emitting display apparatus employing self light-emitting elements such as organic electroluminescence (hereinafter referred to as organic EL) elements. An organic EL display apparatus is configured by an arrangement of a plurality of pixels including the organic EL elements. The organic EL display apparatus has features such as a high-speed responsiveness and a wide viewing angle due to the self light-emitting characteristic, and is expected to be the next-generation display apparatus replacing the conventional liquid crystal display.

However, the self light-emitting element such as the organic EL element deteriorates by being driven. In particular, when the self-emitting elements used in the display apparatus continue displaying a stationary image, the pixels displaying the stationary image deteriorate more rapidly as compared to the other pixels. As a result, screen burn-in phenomenon in which the luminance and chromaticity decrease become recognizable occurs.

To solve such a problem, Japanese Patent Application Laid-Open No. 2010-139836 discusses a technique in which dummy pixels are included in a display apparatus separately from pixels for displaying images. Deterioration information on the dummy pixels is then acquired, and a representative relation between the decrease in the luminance and a light-up time of the display apparatus is derived. Further, an amount of deterioration of each pixel is calculated at the same time from image information displayed on image-displaying pixels, and is sequentially compared with the relation between the decrease in the luminance and the light-up time. An accumulated amount of deterioration of each pixel is thus calculated, and input image data is appropriately corrected to set the accumulated deterioration amount back to zero.

The technique discussed in Japanese Patent Application Laid-Open No. 2010-139836 calculates and then stores in a memory the accumulated deterioration amount. When the input image data is to be corrected, a correction amount is calculated based on the stored accumulated deterioration amount, and the calculated correction amount is applied to the input image data. However, according to such a technique, no measures are provided for the case where the accumulated deterioration amount stored in the memory is lost. In such a case, the input image data is not corrected, so that reliability of the display apparatus is low.

### SUMMARY OF THE INVENTION

The present invention is directed to a display apparatus of high reliability which is capable of appropriately correcting the input image data even when the accumulated deterioration amount (i.e., accumulated luminance decrease amount) stored in the memory is lost.

According to an aspect of the present invention, a display apparatus includes an image display unit in which a plurality of pixels having self light-emitting elements is arranged, a first unit configured to accumulate a luminance decrease amount per unit time for each of the pixels, and to set the accumulated value as a first luminance decrease amount, a second unit configured to detect a current flowing in the self light-emitting element or a voltage value of the self light-emitting element for each of the pixels, and to calculate a second luminance decrease amount from a detected current value or voltage value, and a correction unit configured to correct input image data using one of the first luminance decrease amount or the second luminance decrease amount.

According to an exemplary embodiment of the present invention, the first unit calculates the luminance decrease amount (i.e., the first luminance decrease amount) for each pixel after accumulating the luminance decrease amount for each pixel. Further, second unit calculates the luminance decrease amount of the same level as the first unit without accumulating the luminance decrease amount for each pixel. The input image data can be appropriately corrected based on either of the calculated values. If the data in an accumulated luminance decrease amount storing unit in the first unit is lost, the input image data can be appropriately corrected based on the calculated value of the second unit. Further, the storing unit in the first unit can be replaced by a result of calculation performed by the second unit, so that the data can be restored. A display apparatus of high reliability, capable of appropriately correcting the input image data even when the accumulated luminance decrease amount stored in the memory is lost, can be realized.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration example of a display apparatus according to an exemplary embodiment of the present invention.

FIG. 2 is a graph illustrating an example of a deterioration characteristic curve when an organic EL element is driven at constant voltage.

FIG. 3 is a block diagram illustrating correction of input image data according to a first exemplary embodiment of the present invention.

FIG. 4 is a block diagram illustrating correction of input image data using a first unit according to a second exemplary embodiment of the present invention.

FIG. 5 is a block diagram illustrating correction of input image data using a second unit according to the second exemplary embodiment of the present invention.

### DESCRIPTION OF THE EMBODIMENTS

Various exemplary embodiments, features, and aspects of the invention will be described in detail below with reference to the drawings.

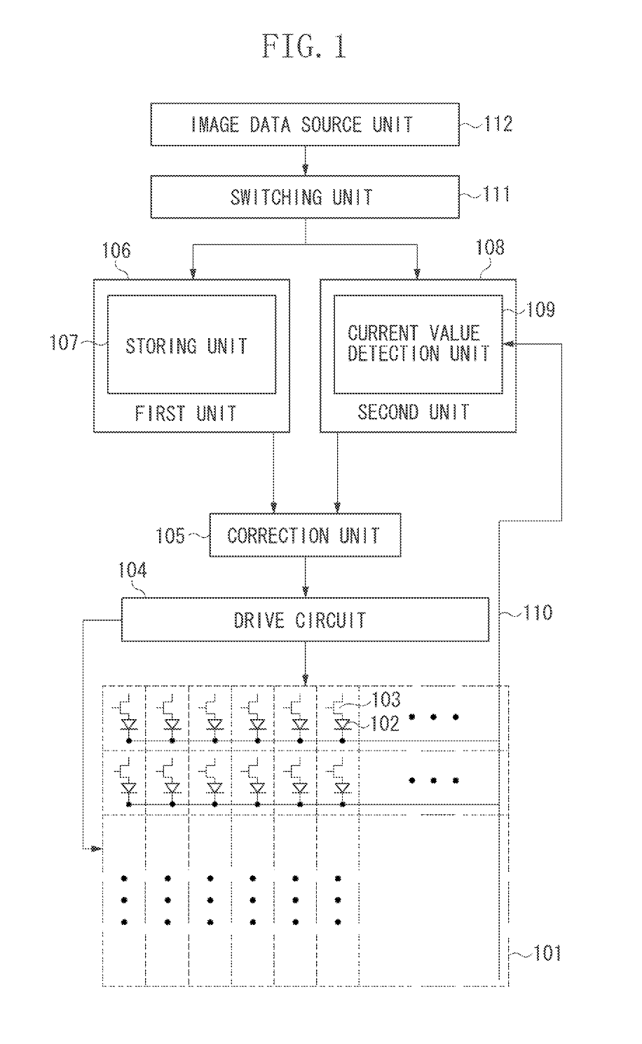

FIG. 1 illustrates a configuration example of a display apparatus according to an exemplary embodiment of the present invention.

Referring to FIG. 1, an image display unit 101 includes a plurality of pixels, each having an organic EL element 102 and a pixel circuit 103 which drives the organic EL element 102, arranged in a matrix form. The image display unit 101 displays image data on these pixels. The organic EL element 102 is configured by an organic light emitting layer sandwiched between an anode electrode and a cathode electrode. When a voltage is applied between the electrodes, the organic light emitting layer emits light. According to the present exemplary embodiment, the organic EL element 102 is driven at constant voltage by the pixel circuit 103 performing control to apply constant voltage to the electrodes. The cathode electrode of each organic EL element 102 is connected to a cathode wiring 110, and all the cathode electrodes are set to the same potential. The organic EL element 102 may also be driven by constant current by the pixel circuit 103 controlling the current flowing into the anode electrode to be constant.

An image data source unit 112 supplies the image data to a first unit 106 or a second unit 108, selected using a switching unit 111. Hereinafter, the image data will be referred to as input image data.

The switching unit 111 includes a switching circuit such as a switch, and switches between correction methods based on the value calculated by the first unit 106 and the value calculated by the second unit 108. The correction method may be selected when the display apparatus is shipped as a product, or may be selected by a user based on a usage status. The decrease in luminance can be more effectively corrected by allowing a user selection of the correction method appropriate for each state, and the screen burn-in phenomenon can thus be reduced. It is not necessary to include the switching unit 111.

The first unit 106 includes a calculation circuit to accumulate the luminance decrease amount per unit time (e.g., 1 frame) for each pixel. The first unit 106 thus calculates the luminance decrease amount for each pixel after accumulation (i.e., the first luminance decrease amount), and transmits the calculated value to a correction unit 105. The calculation process performed by the first unit 106 will be described in detail in the first exemplary embodiment.

According to the present exemplary embodiment, the first unit 106 includes a storing unit 107 which stores the accumulated luminance decrease amount for each pixel. However, it is not necessary for the first unit 106 to include the storing unit 107. If the storing unit 107 is included, the storing unit 107 may be updated based on the calculated value of the first unit 106. As a result, in a subsequent calculation process, the first unit 106 adds the luminance decrease amount per unit time calculated for each pixel to the value before updating in the storing unit 107. The first unit 106 is thus capable of calculating the luminance decrease amount for each pixel after accumulation.

Further, the first unit 106 may include a storing unit which stores the luminance decrease amount per unit time for each pixel, and a storing unit for storing the data used in calculating the luminance decrease amount per unit time for each pixel (e.g., a luminance decrease curve and a table illustrating a relation between gradation and the luminance decrease amount). Such storing units are not limited to being included in the first unit 106 and may be included anywhere within the display apparatus. If such storing units are to be included, a volatile memory can be used as the storing unit for storing the luminance decrease amount per unit time for each pixel. Further, a non-volatile memory can be used as the storing unit 107 and the storing unit for storing the data used in calculating the luminance decrease amount per unit time for each pixel.

The second unit 108 includes a calculation circuit. If the organic EL element 102 is to be voltage-driven, the second unit 108 detects the value of the current flowing in the organic EL element for each pixel when the organic EL element 102 emits light. The second unit 108 then calculates, using the detected current value, the luminance decrease amount (i.e., the second luminance decrease amount) for each pixel when detecting the current value, and transmits the calculated value to the correction unit 105.

If the organic EL element 102 is to be current-driven, the second unit 108 detects the voltage value of the organic EL element 102 for each pixel when the organic EL element emits light. The second unit 108 then calculates, using the detected voltage value, the luminance decrease amount for each pixel when detecting the voltage value, and transmits the calculated value to the correction unit 105.

According to the present exemplary embodiment, the second unit 108 includes a current value detection unit 109 (i.e., an ammeter), which is serially arranged with respect to the cathode wiring 110, to detect the current value flowing in the each organic EL element 102. When the organic EL element 102 is to be current-driven, a circuit which detects a driving voltage for each pixel is disposed in place of the ammeter. Since the second unit 108 calculates by detecting the current value or the voltage value, the process requires time. The time for the second unit 108 to perform the calculation process is thus longer than that of the first unit 106.

Further, the second unit 108 may include a storing unit which stores the data used in calculating the luminance decrease amount for each pixel when detecting the current value (e.g., a current-voltage characteristic curve or a current reduction amount-luminance decrease amount table). Such a storing unit is not limited to being included in the second unit 108 and may be included anywhere within the display apparatus. The non-volatile memory may be employed for such a storing unit.

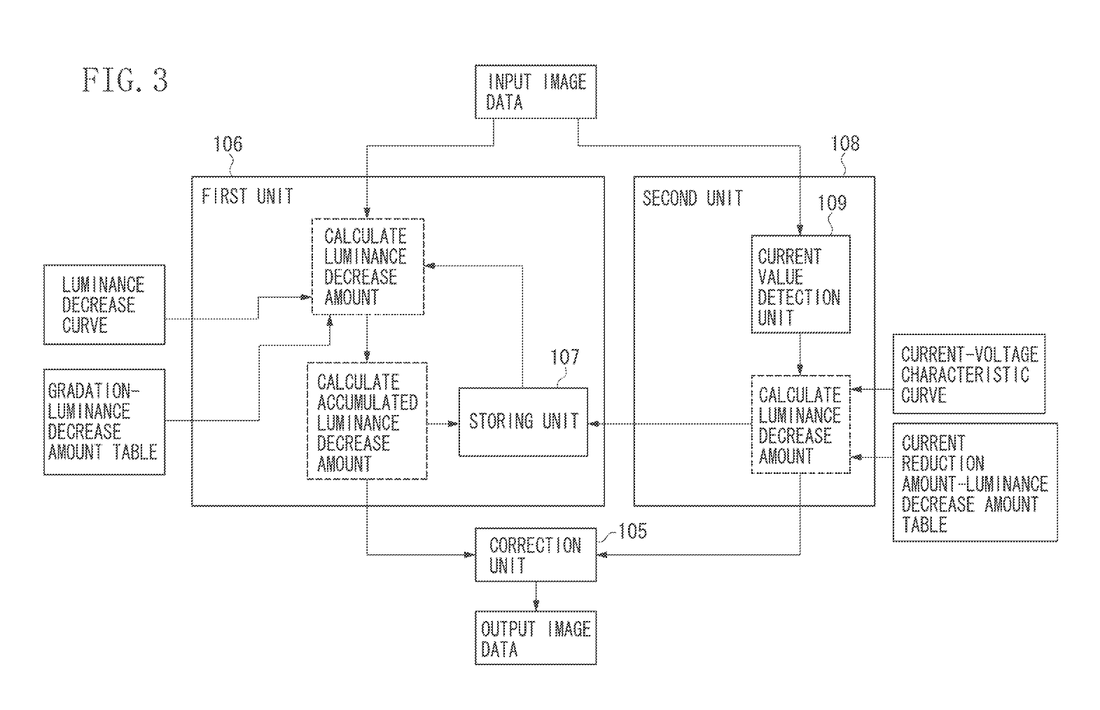

A calculation process performed by the second unit 108 will be described in detail with reference to FIG. 3. An example of the process for calculating the luminance decrease amount based on the current value detected by the current value detection unit 109 will be described below. According to the present invention, the second unit 108 employed in the display apparatus is not limited to the example described below, as long as the value calculated based on the detected current value is the same as the value calculated by the first unit 106.

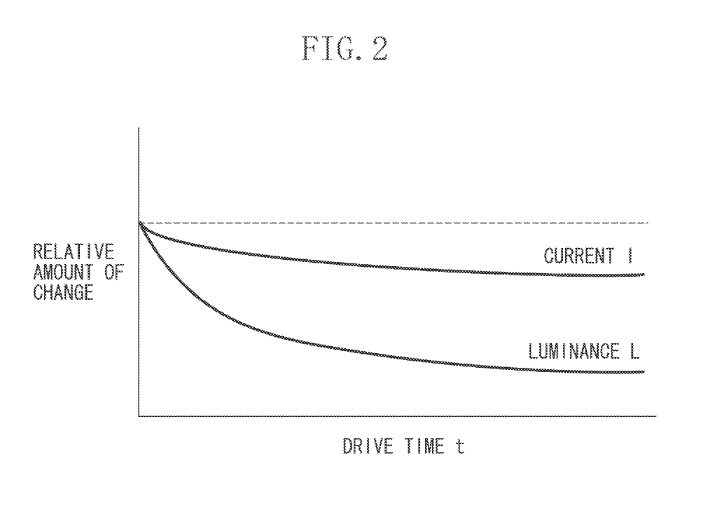

FIG. 2 illustrates a general deterioration characteristic curve of the organic EL element in the case where the organic EL element is driven by applying constant voltage. A drive time “t” is indicated on a horizontal axis, and relative change amounts of a current “I” flowing in the organic EL element and a luminance “L” of the organic EL element are indicated on a vertical axis. When the organic EL element deteriorates, the current flowing therein decreases and the luminance also decreases as compared to the case where there is no deterioration, even if the constant voltage is applied between the anode electrode and the cathode electrode. Further, the decrease amount of the luminance can be expressed as a sum of the decrease amount of the current and a decrease amount of emission efficiency (i.e., a ratio between constant current and the luminance). A method for estimating the brightness decrease amount will be described below based on the above-described relations.

In estimating the luminance decrease amount, it is necessary to previously store in the storing unit the current-voltage characteristic curve and the current reduction amount-luminance decrease amount table of the organic EL element. The current-voltage characteristic curve is a curve indicating the relation between the current I and a voltage V when the organic EL element is not deteriorated, e.g., when shipping the display apparatus as a product. The current reduction amount-luminance decrease amount table is a data table which includes the current reduction amount and the luminance decrease amount as the elements. More specifically, the current reduction amount and the luminance decrease amount per unit time are previously acquired from the curve indicating the relation between the drive time “t” and the current “I”, and the curve indicating the relation between the drive time “t” and the luminance “L”, when a white is displayed at a duty ratio of 100%. The current reduction amount and the luminance decrease amount per unit time are then stored as a record.

The current reduction amount is calculated from the voltage value applied between the anode electrode and the cathode electrode and the current value detected by the current value detection unit 109 when the image data is input to the display apparatus which then emits light. Further, the current reduction amount is calculated from the current-voltage characteristic curve. The brightness decrease amount is then estimated from the calculated current reduction amount, the duty ratio and the gradation of the input image data, and the current reduction amount-luminance decrease amount table. If the duty ratio and the gradation of the input image data are the same as the duty ratio and the gradation on which the current reduction amount-luminance decrease amount table is based, the calculated current reduction amount may be directly compared with the amount indicated in the current reduction amount-luminance decrease amount table. However, if the duty ratio and the gradation of the input image data are not the same as the duty ratio and the gradation on which the current reduction amount-luminance decrease amount table is based, the following procedures are necessary. The calculated current reduction amount is converted to the current reduction amount considering the duty ratio and the gradation of the input image data. The current reduction amount is then compared with the amount indicated in the current reduction amount-luminance decrease amount table.

The luminance decrease amount estimated by the above-described method can be viewed as the accumulated luminance decrease amount when detecting the current value. As a result, correction of the same level as correction based on the calculation value acquired by the first unit 106 can be performed based on the calculation value acquired by the second unit 108 without accumulating the luminance decrease value for each pixel. The correction based on the calculation value acquired by the second unit 108 can be appropriately performed even when the data in the storing unit 107 in the first unit 106 is lost.

Further, the data in the storing unit 107 in the first unit 106 may be updated using the calculated value acquired by the second unit 108. As a result, if the data in the storing unit 107 in the first unit 106 is lost, the second unit 108 can restore the data in the storing unit 107 in the first unit 106. The subsequent correction processes based on the calculation value acquired by the first unit 106 can be appropriately performed.

The correction unit 105 which includes a correction circuit calculates a correction amount based on the calculated value acquired by the first unit 106 or the second unit 108. The correction unit 105 then applies the calculated correction amount to the input image data, and corrects the input image data. The correction unit 105 transmits a drive circuit 104 the corrected input image data.

According to the present exemplary embodiment, there is only one correction unit 105. However, there may be two correction units so that each correction unit 105 respectively performs correction based on the calculated value acquired by the first unit 106 and the calculated value acquired by the second unit 108. If there is no switching unit 111, the correction unit 105 may determine which calculated value to use, acquired by the first unit 106, or the second unit 108. Further, the correction unit 105 may include a storing unit which stores the correction amount. Such a storing unit may be disposed anywhere in the display apparatus and is not limited to inside the correction unit 105. A non-volatile memory can be used as the storing unit.

The drive circuit 104 drives the image display unit 101 and transmits the corrected input image data to the image display unit 101.

As described above, according to the present exemplary embodiment, the input image data can be appropriately corrected even when the data in the storing unit 107 is lost. As a result, a highly-reliable display apparatus can be realized.

According to the present invention, the display apparatus calculates the luminance decrease amount using one of the first and second units 106 and 108. The correction unit 105 then corrects the input image data using the calculated value.

Timing at which the first or second unit calculates the luminance decrease amount and the correction unit 105 performs the correction process will be described below. If the input image data is to be corrected with higher accuracy, it is desirable for the first or second unit to perform the calculation process and the correction unit 105 to perform the correction process for every frame. However, if such a method is performed, it takes time to display the image.

To solve such a problem, the first or second unit may perform the calculation process and the correction unit 105 may perform the correction process for each of a plurality of frames, or for each initial frame after the display apparatus has been activated. The correction unit 105 may then perform the correction process on the frames other than those on which the above-described processes are both performed. A storing unit which stores the correction amount may be disposed in the display apparatus so that the calculated correction amount is stored in the storing unit for the frames on which both of the above-described processes are performed. The correction unit 105 may perform, using the correction amount stored in the storing unit, the correction process on the frames other than those on which both of the above-described processes are performed.

According to the first exemplary embodiment, a correction unit 105 in the display apparatus illustrated in FIG. 1 corrects the input image data based on the calculated value acquired by the first unit 106 or the second unit 108. Further, the values calculated by the first unit 106 and the second unit 108 are used to update the storing unit 107.

FIG. 3 is a block diagram illustrating a correction of the input image data in the display apparatus according to the present exemplary embodiment. According to the present exemplary embodiment, the first or second unit performs the calculation process and the correction unit 105 performs the correction process for each initial frame after the display apparatus is activated.

The calculation process performed in the cases where the switching unit 111 selects the first unit 106 and selects the second unit 108 will be described below. Further, the correction process performed by the correction unit 105 will be described below.

The calculation process performed by the first unit 106 will be described below. In calculating the luminance decrease amount, the first unit 106 uses the luminance decrease curve and the gradation-luminance decrease amount table which are previously stored in the storing unit disposed in the display apparatus. The luminance decrease curve is a curve indicating the relation between the drive time “t” and the luminance “L”. According to the present exemplary embodiment, the luminance decrease curve, acquired when a white is displayed at a duty ratio of 100%, is employed. The luminance decrease amount of dummy pixels disposed outside a display area acquired by a photodiode may be used as the luminance decrease curve.

The gradation-luminance decrease amount table is a data table whose elements are the drive time, the gradation of the input image data, and the luminance decrease amount per unit time (1 frame according to the present exemplary embodiment). More specifically, the luminance decrease amount in a case where a predetermined gradation is displayed for a unit of time at a point on the luminance decrease curve (i.e., the drive time) is previously acquired and stored as a record.

The first unit 106 refers to the storing unit 107, and identifies a drive time t₁ from the point on the luminance decrease curve corresponding to the value in the storing unit 107 before updating. The first unit 106 then acquires, from the gradation-luminance decrease amount table, the luminance decrease amount at time “t₁” in the case where the gradation of the input image data at a duty ratio of 100% is displayed for a unit of time. If the duty ratio of the input image data is 100%, the gradation of the input image data may be compared with the gradation-luminance decrease amount table. However, if the duty ratio of the input image data is not 100%, it is necessary to convert the gradation of the input image data into the luminance decrease amount considering the duty ratio of the input image data after comparing the gradation of the input image data with the gradation-luminance decrease amount table.

The accumulated luminance decrease amount calculation process will be described below. The first unit 106 adds the value in the storing unit 107 before updating to the luminance decrease amount per unit time calculated in the above-described luminance decrease amount calculation process. The first unit 106 thus calculates the accumulated luminance decrease amount, updates the storing unit 107 using the calculated value, and transmits the calculated value to the correction unit 105.

The calculation process performed by the second unit 108 will be described below. When the image data is input and the voltage is applied between the anode electrode and the cathode electrode so that the organic EL element emits light, the second unit 108 detects, using the current value detection unit 109, the value of the current flowing in the organic EL element.

In the luminance decrease amount calculation process, the second unit 108 previously stores, in the storing unit disposed in the display apparatus, the above-described current reduction amount-luminance decrease amount table. The second unit 108 calculates, using the stored data and the current value detected in the above-described current value detection process, the luminance decrease amount. The calculation method is as described above. According to the present exemplary embodiment, the second unit 108 generates a table connecting the current reduction amount—and the luminance decrease amount using the curve indicating the relation between the drive time “t” and the current “I”, and the curve indicating the relation between the drive time “t” and the luminance “L”, in the case where a white is displayed at a duty ratio of 100%. The second unit 108 then updates the data in the storing unit 107 using the calculated value, and transmits the calculated value to the correction unit 105.

The correction unit 105 corrects the input image data as described above, based on the calculated value acquired by the first unit 106 or the second unit 108. The correction unit 105 then transmits the corrected input image data to the drive circuit 104. The correction unit 105 stores in the storing unit the calculated correction amount for the frames on which the first or second unit performs the calculation process and the correction unit 105 performs the correction process. The correction unit 105 performs, using the stored correction amount in the storing unit, the correction process on the frames other than those on which both processes are performed. The storing unit is disposed inside the display apparatus.

The operation will be described below which is performed when the second unit 108 performs the n-th (i.e., “n” is a counting number which is greater than or equal to 1) luminance decrease amount calculation process and first unit 106 performs the (n+1) th luminance decrease amount calculation process. In the accumulated luminance decrease amount calculation process in the (n+1) th luminance decrease amount calculation, the first unit 106 adds, to the value in the storing unit 107 updated by the second unit 108 in the n-th process, the value calculated in the above-described luminance decrease amount calculation process. The first unit 106 thus calculates the accumulated luminance decrease amount.

According to the present exemplary embodiment, if the data in the storing unit 107 in the first unit 106 is lost, the data can be restored as follows. The data can be restored by newly updating the data in the storing unit 107 using the value calculated by the second unit 108. As a result, the subsequent correction processes based on the calculated value of the first unit 106 can be appropriately performed.

According to the second exemplary embodiment, the display apparatus illustrated in FIG. 1 corrects the input image data based on the calculated value acquired by the first unit 106 or the second unit 108 using separate correction units 105, which is different from the first exemplary embodiment. Further, the first unit 106 updates the storing unit 107 using the calculated value acquired thereby. However, the second unit 108 does not update the storing unit 107 using the calculated value acquired thereby, which is different from the first exemplary embodiment.

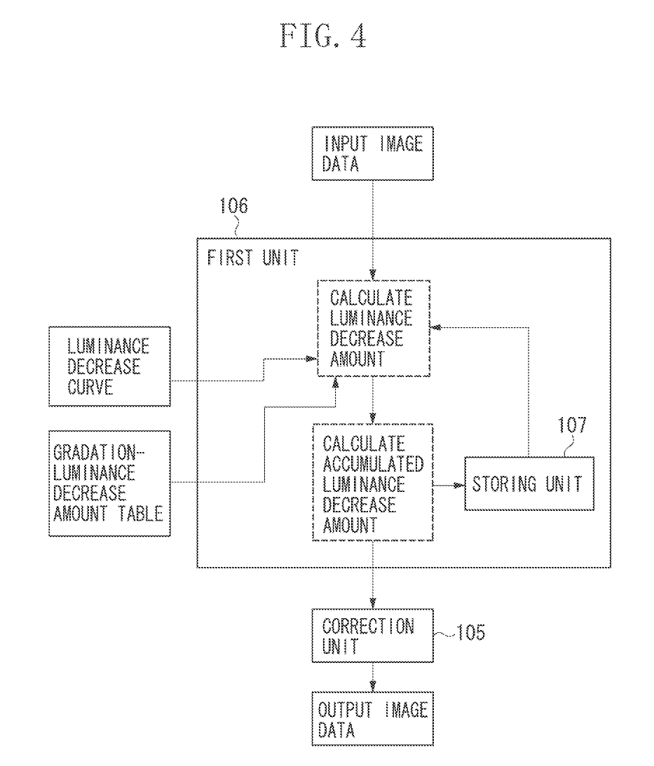

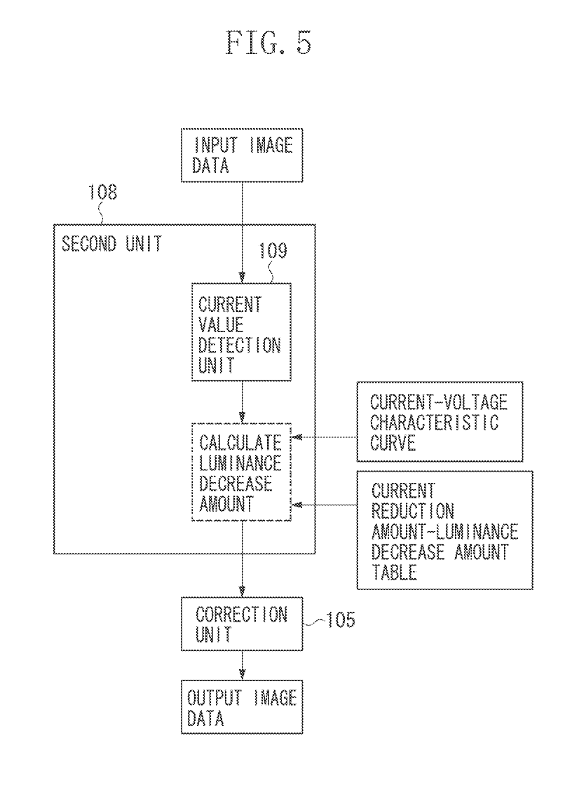

FIG. 4 is a block diagram illustrating the correction process using the first unit 106 in the display apparatus according to the present exemplary embodiment. FIG. 5 is a block diagram illustrating the correction process using the second unit 108 in the display apparatus according to the present exemplary embodiment. According to the present exemplary embodiment, both processes, the calculation process via the luminance decrease amount calculation unit and the correction process via the correction unit 105, are performed at every initial frame after the display apparatus is activated, which is similar to the first exemplary embodiment.

The calculation process performed when the switching unit 111 selects the first unit 106 or the second unit 108, and the correction process performed by each of the correction units 105 are similar to the first exemplary embodiment excluding the above-described differences.

According to the present exemplary embodiment, correction based on the calculated value of the second unit 108 can be appropriately performed even when the data in the storing unit 107 in the first unit 106 is lost.

According to the above-described exemplary embodiments, it is not necessary to limit control processes of the first unit 106 and the second unit 108 to the illustrated processes. For example, a mirroring process in which the data of the accumulated luminance decrease amount is stored in a non-volatile memory may be performed to increase the reliability of the display apparatus.

The present invention is applicable to the self light-emitting display apparatus such as the organic EL display apparatus. The present invention may be applied to a display apparatus which singularly operates, such as a television which receives and displays broadcastings, or a display apparatus which is embedded inside another device such as a digital camera.

While the present invention has been described with reference to exemplary embodiments, it is to be understood that the invention is not limited to the disclosed exemplary embodiments. The scope of the following claims is to be accorded the broadest interpretation to encompass all modifications, equivalent structures, and functions.

This application claims priority from Japanese Patent Application No. 2011-193533 filed Sep. 6, 2011, which is hereby incorporated by reference herein in its entirety.

What is claimed is:

1. A display apparatus comprising:
an image display unit in which a plurality of pixels having self light-emitting elements is arranged;
a first unit configured to accumulate a luminance decrease amount per unit time for each of the pixels, and to set the accumulated amount as a first luminance decrease amount;
a second unit configured to detect a current flowing in the self light-emitting element or a voltage of the self light-emitting element for each of the pixels, and to calculate a second luminance decrease amount from the detected current or the detected voltage; and
a correction unit configured to correct an input image data using one of the first luminance decrease amount or the second luminance decrease amount.

2. The display apparatus according to claim 1, wherein the first unit includes a storing unit configured to store the first luminance decrease amount.

3. The display apparatus according to claim 2, wherein the first init updates the first luminance decrease amount stored in the storing unit by adding the luminance decrease amount per unit time for each pixel to the first luminance decrease amount stored in the storing unit before performing the updating.

4. The display apparatus according to claim 1, wherein the second unit applies a constant voltage to the self light-emitting element and detects the current value for each pixel, and calculates the second luminance decrease amount using the detected current value.

5. The display apparatus according to claim 1, wherein a processing time for the first unit to set the first luminance decrease amount is shorter than a processing time for the second unit to calculate the second luminance decrease amount.

6. The display apparatus according to claim 1, further comprising a switching unit configured to switch between operating the first unit and operating the second unit.

7. The display apparatus according to claim 6, wherein the switching unit causes the second unit to operate when data in the storing unit is lost.

8. The display apparatus according to claim 7, wherein the first luminance decrease amount stored in the storing unit is replaced by the second luminance decrease amount when the second unit operates.
